(19) United States
(12) Patent Application Publication
(10) Pub. No.: US 2004/0084895 A1
(43) Pub. Date: May 6, 2004

(54) System for reducing health-insurance costs including fraud by providing medical histories

(76) Inventor: Harvey Blum, Miami, FL (US)

Correspondence Address: Harvey Blum, 1552 NE Quayside Terrace, Miami, FL, 33138, US

(21) Appl. No.: 10/273,553

(22) Filed: Oct. 19, 2002

(51) Int. Cl. B42D 15/00

(52) U.S. Cl. 283/75

(57) ABSTRACT

A system for reducing health-insurance costs including fraud for patients uses an identification card to allow doctors to obtain a patient's medical history. The identification card can either hold the medical history itself or can link the provider to a database containing the medical history. A method of using the card requires the card to be present to bill; this prevents fraud by the provider. A method of using the card requires the card to be matched to a photograph of the user; this prevents fraud by the card holder. The system includes a database of patients. According to a method, the database of patients can be monitored to check the frequency of diseases.

### BACKGROUND OF THE INVENTION

1. Field of the Invention

The invention relates to health insurance. More specifically, the invention relates to systems for reducing costs, especially for patients who may be away from the typical provider.

2. Description of the Related Art

Previous insurance systems incur significant costs when an insured patient leaves their typical provider. For example, an insured patient has a medical problem while on vacation, out of town, or during a time when the doctor's office is closed: for example, a primary provider's office is closed due to the time of day or the doctor is on vacation. The patient has fallen and is brought to a hospital or nearby office or patient becomes unconscious and is unable to communicate. The examining doctor does not know the patient's medical status before seeing him. The patient communicates what he is able to, and the doctor checks the patient's wallet and tries to gather as much information as possible.

Examination will provide some information, but not nearly enough. The doctor will stabilize the patient and then hospitalize the patient to find out what doctor needs to know. Such information includes prior medical conditions, previous attacks of same condition patient is now being treated for, how many of these same attacks, and with what frequency these attack occur, what work-up in the office and hospital he has had for these same problems and others problems, the medications patient is on, what changes in medications were made and when they were made, what surgical procedures were done and when they were done, what complications the patient has had from medication, surgery; what reactions to drugs, food, weather, seasons of the year, and so forth; what immunizations patients has had and when and what reactions has he had to these immunizations, and family history.

The doctor will then order tests, depending on the results of the physical examination while the patient is in the hospital. This could range from blood work to a MRI and entail several days in the hospital along with consultation from different specialties. Medication will be given to patient that may or may not be effective or cause negative reactions requiring further hospital days. In today's environment, there is a great deal of redundant and unnecessary medical workup done so as not to expose doctor to a lawsuit.

The current system is plagued by redundancy, mismanagement, fraud and at times sub par treatment of the patient.

At the present time the patient goes to his/her primary care provider and is treated and leaves the office putting trust in the hands of the physician and office workers in that they will make the correct adjustments to the patient's records. The patient also, has no record of his/her own medical history, problems, and workups. In all fairness, whether or not the primary care providers have good intentions, mistakes, purposeful or not, are made. This can lead to inadequate treatment of the patient.

At the present time, a patient who wants to keep medical records must carry a complete hardcopy of them. This process is bulky, inefficient, and can lead to mistakes, whether fraudulent or inadvertent. Patients should have access to their medical history at all times thus improving quality of care.

At the present time, a patient arrives at the emergency room for any number of reasons. Most commonly, the patient feels ill, sick, hurt, etc. and his/her PCP instructs patient to go to the ER, this commonly happens in the patient's local area. Other scenarios include patients from another state (very common in the southern states secondary to northerners traveling down south “snow birds’) and these patients commonly are seen by unfamiliar ER physicians and are admitted by unfamiliar PCP's and/or specialists. This also happens in other countries; again, unfamiliar physicians see the patients.

At the present time, the physicians must rely on information from the patient, which is notoriously inaccurate and he/she must try and obtain old records from wherever the patient has been treated before. This is most often a prolonged, inefficient, inaccurate, and time-consuming effort. This can lead to sub-par treatment of the patient and most often leads to redundant labs, tests, procedures and prolonged hospital stays. With new chip technology, physician would have access to patients' medical history. If the physician had access to this information, he/she would be more efficient in treating the patient. This would cut down on redundant tests, labs, and procedures, and will ultimately lead to decreased hospital stays thus decreasing health care costs. Other problems inherent in this system are related to, as above, mistakes either inadvertent or fraudulent. If providers such as medicate and insurance companies had access to patient's information (i.e., labs, tests, procedures, hospital stays, etc.) and could monitor the accuracy of the information this would cut down on mistakes inadvertent or fraudulent and decrease health care costs.

The system in place now falls short of addressing these issues. The system now deals with this lack of universal patient information by placing restrictions on certain labs, tests, procedures, and hospital stays. This system was put in place in an attempt to keep costs low. The fact is that if there was a system in place that provided patient information and ultimately allowed for direct access to the examination by physicians and health care providers such as Medicare and insurance companies quality of care would be improved and health care costs would be decreased for the reasons stated above.

### SUMMARY OF THE INVENTION

It is accordingly an object of the invention to provide a system for reducing health-insurance costs including fraud for patients that overcomes the hereinafore-mentioned disadvantages of the heretofore-known systems of this general type and that links a patient to a database including their medical history.

If the patient needs further workup elsewhere his or her medical history can be accessed easily with new chip technology and decisions about the patient's medical care made more accurately.

Providers such as Medicare and insurance companies could have access to all visits, procedures, workups and laboratory tests whereas now these companies rely on physicians and their staff, hospitals and their staff, and clinics and their staff to accurately provide the information. This information again can be inaccurate whether purposeful or not and with new chip technology can be directly accessed thereby foregoing the necessity of relying on physicians, hospitals, clinics and their staff to provide the information. This obviously will cut down on fraudulent claims but also improve efficiency and most importantly improve quality of care.

Doctors will be provided everything that he does not know with prior art. When the patient enters hospital or other facility for medical problems, all the information on the patient will be known. With this invention, the patient can be tracked medically 24/7 while primary care office is not available.

The invention is a chip with all medical history and tests for this patient on it. This chip can be carried in a patient's identification card, which is carried by him at all times. Each time the patient sees his doctor or visits his medical office, the chip is updated with new information. Updating of chip can be accomplished by handing card with chip to office personnel. The patient is then seen by doctor who either writes on “palm” pilot or dictates information directly into office computer. This chip is then updated and card is then returned to patient. Other information available on chip would be blood type and possibly DNA.

The invention is a universal card that holds the patient's entire medical history and the hardware and software that allows access to this information.

The card will be given to the patient and the patient will bring it to the physician's office. The office has the hardware and software to access the data on the card for patients past medical history. The patient will be treated and physician will update the card with now data via dictation and or other data apparatus (i.e., PALM® technology, writing tablet DICTAPHONE®, etc.). At this time, either the data can be either directly to the insurance company and/or Medicare or a signal can be sent to the above company and/or they can access the information directly. This will improve patient care by having a more precise record system and by having patients' histories at the physician's fingertips. This will out down on health care costs by decreasing unnecessary and redundant labs, tests, and procedures. In addition, by decreasing the number of mistakes either inadvertent or fraudulent made by health care providers and their staff.

Other features which are considered as characteristic for the invention are set forth in the appended claims.

Although the invention is illustrated and described herein as embodied in a system for reducing health-insurance costs including fraud for patients, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a healthcare system; and

FIG. 2 is a schematic view of a healthcare system.

### DESCRIPTION OF THE PREFERRED EMBODIMENTS

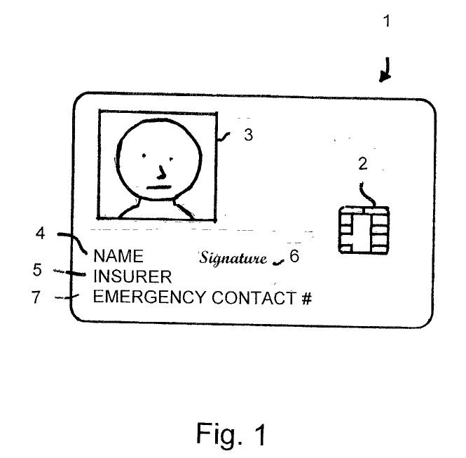

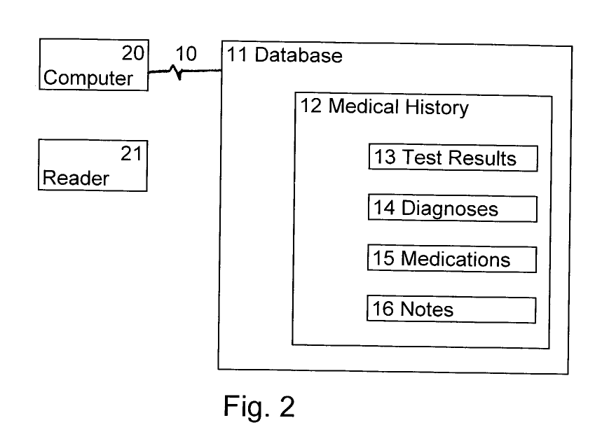

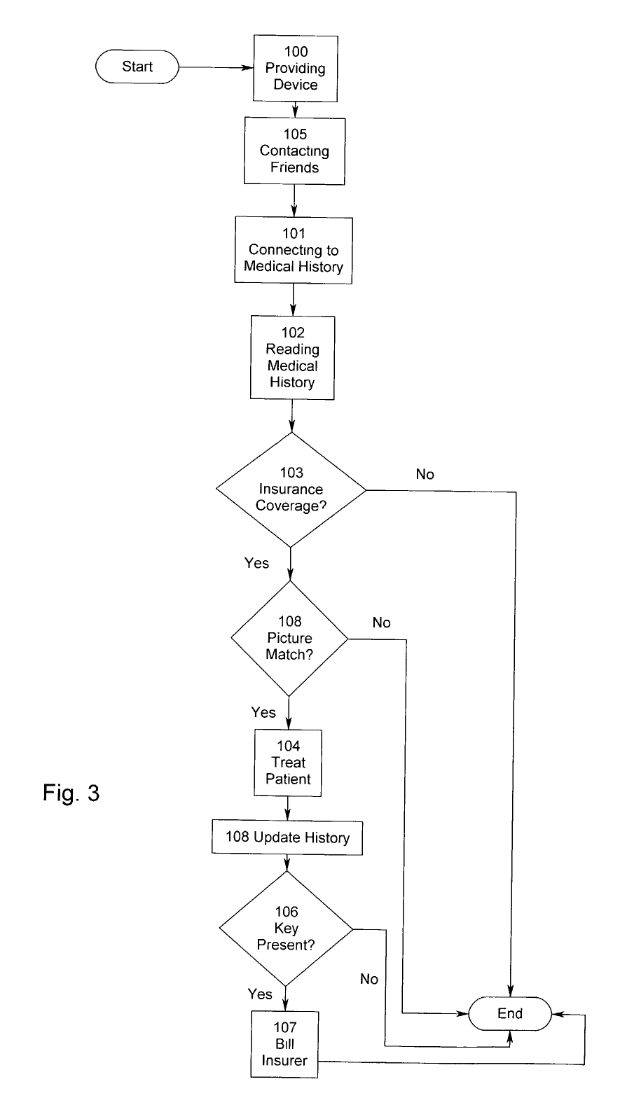

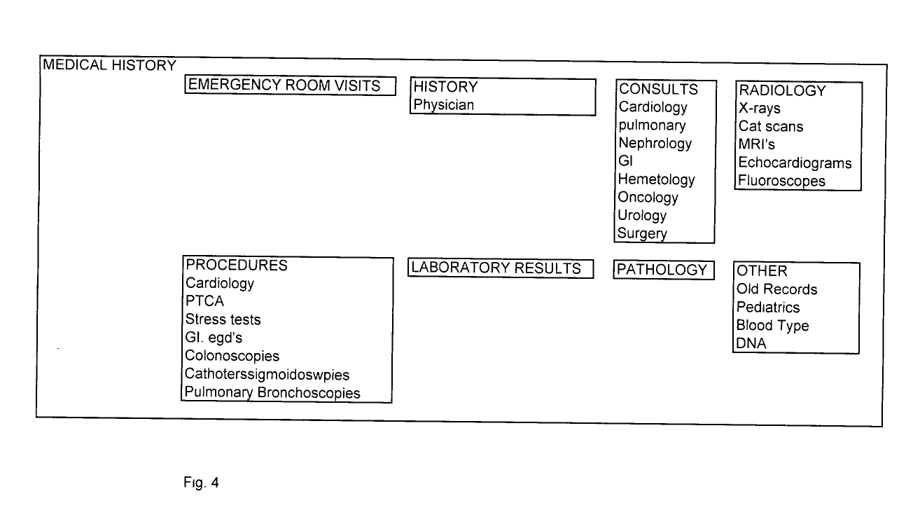

Referring now to the figures of the drawing in detail and first, particularly, to FIG. 1 thereof, there is seen a card 1. The card 1 includes patient information such as a photograph 3, name 4, signature 6, and an emergency contact telephone number 7.

In addition, the card 1 includes insurance information such as the name of the insurer 5. In addition, the card can include coverage information such as an insurance plan name, limits of coverage, deductibles, and exclusions.

The card includes a key, preferably a smartcard chip 2, required for unlocking a connection 10 to a medical history 12 of the patient.

Preferably, the medical history 12 includes each patient's test results 13, diagnoses 14, medications taken 15, and healthcare provider notes 16.

In one preferred embodiment, the medical history 12 is stored locally on the card 1 device with said patient information and said insurance information. In the case of a smartcard, the medical history 12 is stored electronically in the smartcard chip 2.

In an alternate embodiment, the medical history 12 is stored remotely on a networked database 11. A computer 20 with a smartcard reader 21 is connected via a network 10 to the database 11.

The computer 20 reads the medical history 12. Depending on the embodiment, the computer 20 reads the medical history 12 directly from the card 1 or from a database 11. The computer 20 is also used for supplementing the medical history 12 with new data. Preferably, the medical history 12 includes data in a standardized format for easy comparison.

The device, system, and methods reduce healthcare costs. By making medical histories available to providers, repeated tests are not necessary. For example, if a test were recently ordered, then a new doctor could access the old results and save the costs of conducting a new test. Likewise by including data in a standardized format, quality of care is improved because a health-care provider now has baseline with which to compare new tests. For example, by comparing a new EKG to a previous one, a doctor can quickly determine whether a heart attack has occurred.

a patient with card in hand, pocket, or handbag, or other arrives in an ER. Not withstanding or dependant upon the patient's state of health the patient has all of her medical history in or on the person. In other words, if the patient is incapacitated secondary to stroke, syncope, drug use/abuse, etc., the patient's medical history can be obtained. A system will be in place and made common place and known to EMS/fire rescue that they are aware that this card is present and attainable at the said patients household and is located in purse or “box”, or around neck on chain, i.e. dog tags.

This patient has a health related problem and is triaged by the triage nurse (or whatever system that particular hospital has in place) in the ER. The nurse (or other) places card in hardware (provided by company) and the patient's information goes into the hospital computer system and/or ER computer system. The ER physician is able to access this information and is better able to treat patient. The ER physician can determine if this particular problem has been present before what and how they were treated and what workups were done in the past.

This will cut down on health care costs by decreasing unnecessary and redundant labs, tests, and procedures. In addition, by decreasing the number of mistakes either inadvertent or fraudulent made by health care providers and their staff. This will lead to improvement of patient can secondary to the same reasoning as above and will decrease hospital costs and thus health care costs as above.

The ER physician at some time in the course of treatment makes a decision as to admit the patient or not. The above information will help in making this decision. Once the decision is made to admit the patient a primary care physician and/or specialist is called to ad6t. At this time, the PCP or Specialist makes the decision to admit or not. With a full history in hand, the physician is better able to make this decision.

The patient is treated. The card is either updated by the medical records department or other. At this point, Medicare and/or insurance companies can access this information. Again, this will cut down on health care costs by decreasing unnecessary and redundant labs, tests, and procedures. In addition, by decreasing the number of mistakes either inadvertent or fraudulent made by health care providers and their staff.

This card can be used anywhere in the world.

Menu: (will encompass all the disciplines under each heading and all dates from most recent)*

I. Emergency Room Visits (From Most Recent Dates)

II. History and Physician

III. Consults

Divided into subspecialties i.e.: cardiology, pulmonary, nephrology, GI, heme/oncology, urology, surgery, etc.

IV. Radiology

X-rays, Cat scans, MRI's, Echocardiograms, fluoroscopes, etc.

V. Procedures

Cardiology Caths/PTCA, stress tests (all types), etc.; GI. egd's, colonoscopies, sigmoidoswpies pulmonary bronchoscopies, etc.

VI. Labs

VII. Pathology

VIII. Other:

Old records including pediatrics (unless card already given to person at childbirth or as a child to be maintained by parent or guardian), blood type, and possibly DNA

I claim:

1. A card for identifying a patient, improving medical treatment of the patient, and reducing insurance cost and fraud, comprising:
patient information;
insurance information; and
a key required for forming a connection to a medical history of the patient.

2. The device according to claim 1, wherein said medical history includes test results of the patient.

3. The device according to claim 1, wherein said medical history includes diagnoses of the patient.

4. The device according to claim 1, wherein said medical history includes medication information regarding medications taken by the patient.

5. The device according to claim 1, wherein said medical history includes healthcare provider notes.

6. The device according to claim 1, wherein said patient information includes emergency contact information.

7. The device according to claim 1, wherein said insurance information includes coverage information.

8. The device according to claim 1, wherein said insurance information includes insurer information.

9. The device according to claim 1, wherein said medical history is stored locally on said device with said patient information and said insurance information.

10. The device according to claim 1, wherein said device is a smartcard.

11. The device according to claim 1, wherein:
the medical history is stored remotely on a networked database; and
said connection is a computer network connecting to said networked database.

12. The device according to claim 1, wherein said key can be read by a computerized workstation.

13. The device according to claim 1, wherein said patient information includes a photograph of the patient.

14. A system for identifying a patient, improving medical treatment of the patient, and reducing insurance cost, comprising:
a medical history of the patient;
a device including patient information, insurance information, and a key for forming a connection to said medical history of the patient.

16. The system according to claim 14, including a computer for reading said medical history.

16. The system according to claim 14, including a computer for supplementing said medical history.

17. The system according to claim 14, wherein said medical history is in a standardized format.

18. A method for identifying a patient, improving medical treatment of the patient, and reducing insurance cost and fraud, which comprises:
providing a device including patient information, insurance information, and a key for forming a connection to a computer-readable medical history of the patient;
connecting a computer to the medical history with the connection information;
reading the medical history on the computer; and
treating the patient by using the medical history.

19. The method according to claim 18, which further comprises determining insurance coverage of the patient from the insurance information.

20. The method according to claim 18, which further comprises contacting friends of the patient using the personal information.

21. The method according to claim 18, which further comprises requiring the key before billing an insurer.

22. The method according to claim 18, which further comprises:
providing a photograph of the patient on the device; and
verifying an identity of the patient by checking the photograph.

23. A system for tracking diseases among patients, comprising:
a database containing a respective medical history for each of the patients; and
a respective card for each of the patients; each card including respective patient information, insurance information, and a key required for forming a connection to said database; said card being required for updating the respective medical history of the patient.

24. The system according to claim 23, wherein said medical histories of the patients are anonymous.

25. A method for tracking diseases among patients, which comprises:
providing a database containing medical histories of the patients;
identifying each patient with a card;
providing patient information on said card;
providing insurance information on said card;
requiring a key to form a connection to said database;
writing an occurrence of a disease to said respective medical history in said database; and
monitoring frequencies of the disease.
